(19) United States
(12) Patent Application Publication
(10) Pub. No.: US 2007/0212521 A1
(43) Pub. Date: Sep. 13, 2007

(54) Anisotropic Conductive Film and a Method of Manufacturing the Same

(75) Inventors: Hisami Bessho, Aichi (JP); Hideyuki Sato, Aichi (JP); Akio Sato, Aichi (JP); Masatsugu Shimomura, Hokkaido (JP); Masaru Tanaka, Hokkaido (JP); Hiroshi Yabu, Hokkaido (JP)

Correspondence Address: OLIFF & BERRIDGE, PLC, P.O. BOX 19928, ALEXANDRIA, VA, 22320, US

(73) Assignee: Tokai Rubber Industries, Ltd., Komaki-shi (JP)

(21) Appl. No.: 10/593,622

(22) PCT Filed: Mar. 29, 2005
(86) PCT No.: PCT/JP05/06584

§ 371 Date: Nov. 21, 2006

(30) Foreign Application Priority Data
Mar. 30, 2004 (JP) 2004-097384
Feb. 25, 2005 (JP) 2005-049832

(51) Int. Cl. B32B 3/10

(52) U.S. Cl. 428/137

(57) ABSTRACT

To provide an anisotropic conductive film which can respond to increasing pitch reduction of connection targets while maintaining connection reliability, and can be manufactured at a lower cost than conventional, and to provide a method of manufacturing the same. The anisotropic conductive film is provided with a porous film consisting of polymer, having numerous holes penetrating in a film thickness direction, the holes being in a honeycomb arrangement and having inner wall surfaces which curve outwards, a conductive material that fills the holes in the porous film, and an adhesive layer coated on both surfaces of the porous film. The porous film is formed by leaving a supporting substrate on which cast is a polymer solution where a polymer is dissolved in a hydrophobic, volatile organic solvent, under high humidity conditions.

### TECHNICAL FIELD

The present invention relates to an anisotropic conductive film and a method of manufacturing the same, and more specifically, to an anisotropic conductive film suitably used for connection of electronic parts and substrates which have a narrow conductor spacing, and a method of manufacturing the same.

### BACKGROUND ART

In recent years, as electronic equipment becomes more sophisticated and miniaturized, the necessity of electrically connecting plural conductors separated by a narrow pitch is increasing. Such a need exists in the field of liquid crystal displays (LCD), for example when an electrode of a TAB (Tape Automated Bonding) on which a drive IC is mounted in a TCP (Tape Carrier Package), is connected to an electrode of a liquid crystal panel, and when a drive IC is directly connected on a glass substrate of a liquid crystal panel (Chip On Glass: COG).

In these connections, an anisotropic conductive film (ACF) which has conductivity in the film thickness direction but has insulation in the film surface direction, is widely used. The structure and connection principle of a typical ACF are shown in FIGS. 16A and 16B.

As shown in FIGS. 16A and 16B, a typical ACF 100 usually has a structure where conductive particles 102 are distributed in an adhesive resin 101 formed in a film shape. If this ACF 100 is placed between a chip 103 and a substrate 104, for example and thermocompression bonding is performed, the resin 101 flows out, and the conductive particles 102 are crushed between chip electrodes 105 and substrate electrodes 106. When the resin 101 hardens in this state, the electrodes 105, 106 become electrically connected via the conductive particles 102. On the other hand, the adjacent electrodes 105 (106) are electrically insulated by the resin 101. The chip 103 and the substrate 104 are also mechanically connected by the hardening of the resin 101.

Here, the main purposes of using conductive particles are (1) making an electrical connection between the electrodes, (2) providing insulation between circuits, and (3) absorbing variations in height of the electrodes or warpage in the substrate.

To achieve these purposes, for example, Non-patent document 1 (Motohide Takeichi, “Flip-chip mounting techniques using anisotropic conductive films”, Electronic Materials, Kogyo Chosakai Publishing, Inc., May 2001, Appendix, p. 130-p. 133) discloses the use, as the conductive particles, of resin plated particles wherein a metal plating of Ni—Au or the like is given to very fine resin particles of about 3-5 μm in size having an elastic deformation region.

The same Non-patent document discloses the use of particles coated with an insulating material on the surface as the conductive particles. In this case, in the film thickness direction, the insulating material on the particle surface is destroyed by compression bonding forces, so the conductive particles and electrode are electrically connected to each other. On the other hand, in the film surface direction, the insulating material on the particle surface is not destroyed, so insulating properties are maintained even if the particles come into contact with each other.

In Patent document 1 (JP-A 8-273442), a different type of ACF from that shown in FIGS. 16A and 16B is disclosed, which is prepared by applying a water-soluble film to both surfaces of a thermoplastic film, and filling holes penetrating in the film thickness direction with a conductive material.

In Non-patent document 2, Masatsugu Shimomura, “Formation and functionalization of nano/meso hole structures by self-organization of polymer materials”, Functional Materials, CMC Publishing CO., LTD., October 2003, Vol. 23, No. 10, p. 18-p. 26), and Non-Patent Document 3 (Masatsugu Shimomura, “Pattern-forming by self-organization and its application to microprocessing techniques”, Materia, the Japan Institute of Metals, 2003, Vol. 42, No. 6. p. 457-p. 460), although not an ACF, a porous film consisting of polymer, having a honeycomb structure wherein holes are regularly arranged in the film thickness direction, is disclosed.

Also, in Patent document 2 (JP-A2003-80538), although not an ACF, a porous film consisting of polyimide, having a honeycomb structure wherein thin holes are regularly arranged in the film thickness direction, is disclosed.

Due to the miniaturization of electronic parts and the like, when the conductor pitch between connection targets becomes narrower, to ensure insulation in the film thickness direction, in the ACF shown in FIGS. 16A and 16B, the conductive particles dispersed in the adhesive resin must be made smaller in diameter. However, from the viewpoint of ensuring conductivity in the film thickness direction, it is difficult to make the conductive particles smaller in diameter to be less than the variations in height of the conductors provided to the connection targets.

Moreover, if the size of the conductive particles is reduced, to ensure sufficient conductivity, the distribution density of conductive particles must be increased. However, if the distribution density of conductive particles is increased, it becomes difficult to ensure insulation in the film surface direction, and reliability decreases.

Therefore, in the ACF shown in FIGS. 16A and 16B, there is a natural limit to responding to pitch reduction of the connection targets. It was thus difficult to achieve a narrower pitch than the conductor pitch of the connection targets (currently, about 40 μm).

In the ACF disclosed in Non-patent document 1, it is thought that since the surface of the conductive particles is coated with an insulating material, it is easy to maintain insulation in the film surface direction even if the distribution density of electrically conductive particles is increased. However, even in this ACF, due to the same reason as above, it is difficult to reduce the size of the electrically conductive particles to be less than the variations in height of the conductors provided to the connection targets. For this reason, even with this ACF, there is a natural limit to responding to pitch reduction of the connection targets. It is also inherently difficult to coat very fine particles with an insulating material.

On the other hand, in the ACF disclosed in Patent document 1, the holes penetrating in the film thickness direction are filled with an electrically conducting material, so compared with an ACF where the conductive particles are dispersed in a resin, it is thought to be easier to respond to pitch reduction of the connection targets. However, in this ACF, in order to provide many fine throughholes in the film thickness direction, X-rays or SR (synchrotron radiation), etc., must be used. Therefore, manufacturing costs increased and the ability to mass produce long objects was low.

In Non-patent document 2 and Non-patent document 3, the use of a porous film consisting of polymer, having a honeycomb structure wherein thin holes are regularly arranged in the film thickness direction, as a base material for growing cells is mentioned, but there is absolutely no disclosure or suggestion about its use as an anisotropic conductive film material.

It is therefore an object of the invention, which was conceived in view of the above problems, to provide an anisotropic conductive film which can respond to increasing pitch reduction of connection targets while maintaining connection reliability, which can be manufactured at a lower cost than conventional, and to provide a method of manufacturing the same.

### DISCLOSURE OF THE INVENTION

To achieve the objects and in accordance with the purpose of the present invention, as embodied and broadly described herein, an anisotropic conductive film according to the invention includes a porous film consisting of polymer, having numerous holes penetrating in a film thickness direction, the holes being in a honeycomb arrangement and having inner wall surfaces which curve outwards, a conductive material that fills the holes in the porous film, and an adhesive layer coated on both surfaces of the porous film.

At this time, the polymer forming the porous film preferably consists of one or more polymers selected from among polysulfone, polyethersulfone, polyphenylene sulfide, polyimide, polyamide-imide, siloxane-modified polyimide, siloxane-modified polyamide-imide, polyether imide and polyether ether ketone.

Here, the porous film is preferably formed by leaving a supporting substrate on which cast is a polymer solution containing at least a hydrophobic, volatile organic solvent, a polymer soluble in this organic solvent and an amphiphilic material, in the atmosphere at a relative humidity of 50% or more.

Otherwise, the porous film and the conductive material are preferably formed by leaving a supporting substrate on which cast is a polymer solution containing at least a hydrophobic, volatile organic solvent, a polymer soluble in this organic solvent, an amphiphilic material and a conductive material, in the atmosphere at a relative humidity of 50% or more.

When the porous film, or the porous film and the conductive material are formed as above, the polymer soluble in the organic solvent which is preferably used includes one or more polymers selected from among polysulfone, polyethersulfone, polyphenylene sulfide, siloxane-modified polyimide and siloxane-modified polyamide-imide.

Alternatively, the porous film may be formed by leaving a supporting substrate on which cast is a polymer solution containing at least a hydrophobic, volatile organic solvent and an amphiphilic polymer, in the atmosphere at a relative humidity of 50% or more.

Otherwise, the porous film and the conductive material may be formed by leaving a supporting substrate on which cast is a polymer solution containing at least a hydrophobic, volatile organic solvent, an amphiphilic polymer and a conductive material, in the atmosphere at a relative humidity of 50% or more.

When the porous film, or the porous film and the conductive material are formed as above, the amphiphilic polymer preferably used is a polyionic complex of a polymer having a hydrophobic group introduced into at least one of a main chain and a side chain, with a cationic lipid, for example, a polyionic complex of a polyamic acid with a cationic lipid. When the polyionic complex of a polyamic acid with a cationic lipid is used as the amphiphilic polymer, the porous film is preferably imidized after film-forming.

In addition, in the anisotropic conductive film according to the invention, a diameter of the holes is preferably smaller than the narrowest a gap between plural conductors provided to connection targets, and a gap between the holes is preferably smaller than the narrowest width of the conductors.

In addition, in the anisotropic conductive film according to the invention, the conductive material preferably consists of a group of conductive particles. The conductive particles preferably used include particles of metal. The metal preferably used includes one or more metals selected from among Ag, Au, Pt, Ni, Cu and Pd. A group of the metal particles filling the holes are preferably fusion bonded by heating to be integral.

In addition, in the anisotropic conductive film according to the invention, the adhesive layer is preferably a prepreg in which a thermosetting resin is in a semi-cured state, and the thermosetting resin preferably used includes an epoxy resin.

On the other hand, a method of manufacturing an anisotropic conductive film according to the invention includes the steps of forming a porous film consisting of polymer, having numerous holes penetrating in a film thickness direction, the holes being in a honeycomb arrangement and having inner wall surfaces which curve outwards, filling the holes in the porous film with a conductive material, and coating both surfaces of the porous film with an adhesive layer.

The porous film is preferably formed by leaving a supporting substrate on which cast is a polymer solution containing at least a hydrophobic, volatile organic solvent, a polymer soluble in this organic solvent and an amphiphilic material, in the atmosphere at a relative humidity of 50% or more.

Alternatively, the porous film is preferably formed by leaving a supporting substrate on which cast is a polymer solution containing at least a hydrophobic, volatile organic solvent and an amphiphilic polymer, in the atmosphere at a relative humidity of 50% or more.

In addition, another method of manufacturing an anisotropic conductive film according to the invention includes the steps of forming a porous film consisting of polymer, having numerous holes penetrating in a film thickness direction, the holes being in a honeycomb arrangement, having inner wall surfaces which curve outwards and being filled with a conductive material, and coating both surfaces of the porous film with an adhesive layer.

Here, the porous film is preferably formed by leaving a supporting substrate on which cast is a polymer solution containing at least a hydrophobic, volatile organic solvent, a polymer soluble in this organic solvent, an amphiphilic material and a conductive material, in the atmosphere at a relative humidity of 50% or more.

Alternatively, the porous film is preferably formed by leaving a supporting substrate on which cast is a polymer solution containing at least a hydrophobic, volatile organic solvent, an amphiphilic polymer and a conductive material, in the atmosphere at a relative humidity of 50% or more.

The anisotropic conductive film according to the invention is provided with a porous film, having numerous small holes in a honeycomb arrangement, and a conductive material fills the holes in this porous film.

Therefore, even if the conductor pitch of the connection targets becomes narrower, it is easy to respond to pitch reduction by decreasing the diameter of the holes in a honeycomb arrangement, and the gaps between them. Also, as adjacent holes are mutually isolated and these holes are filled with a conductive material, conductivity in the film thickness direction and insulation in the film surface direction can be fully maintained. Therefore, according to the anisotropic conductive film of the invention, in contrast to the conventional anisotropic conductive film wherein conductive particles are dispersed in a resin, it is possible to respond to further reduction of a pitch between the connection targets while maintaining connection reliability.

Further, the aforesaid porous film can be formed simply by a method wherein a supporting substrate on which cast is a polymer solution containing at least a hydrophobic, volatile organic solvent, a polymer which is soluble in this organic solvent and an amphiphilic material, or a polymer solution containing at least a hydrophobic, volatile organic solvent and an amphiphilic polymer, is left in the atmosphere at a relative humidity of 50% or more.

Therefore, although numerous small holes are provided in the film thickness direction, there is absolutely no necessity to use costly X-rays, SR (synchrotron radiation) or the like. Therefore, the anisotropic conductive film of the invention has such advantages that it can be manufactured simply and cheaply and that long objects can be easily mass-produced.

If the polymer forming the porous film consists of one or more polymers selected from among polysulfone, polyethersulfone, polyphenylene sulfide, polyimide, polyamide-imide, siloxane-modified polyimide, siloxane-modified polyamide-imide, polyether imide and polyether ether ketone, the anisotropic conductive film has superior heat resistance.

When the porous film and the conductor material mentioned above are formed by a method wherein the supporting substrate, on which cast is a polymer solution containing at least a hydrophobic, volatile organic solvent, a polymer soluble in this organic solvent, an amphiphilic material and a conductive material, or containing at least a hydrophobic, volatile organic solvent, an amphiphilic polymer and a conductive material, is left in the atmosphere at a relative humidity of 50% or more, the porous film in which holes are filled with a conductive material in the film-forming step can be formed more simply.

Therefore, in the case of an anisotropic conductive film using such a porous film, since there is no need to refill the holes in the porous film with the conductive material, manufacture is simpler and more economical, and mass production on an industrial scale is easier.

When forming the porous film, or the porous film and the conductive material, by the above technique, if a polyionic complex of a polymer wherein hydrophilic groups are introduced into the main chain and/or side chain, with a cationic lipid, for example a polyionic complex of a polyamic acid with a cationic lipid, etc., is used as the amphiphilic polymer, an anisotropic conductive film having a porous film consisting of a polymer which does not dissolve easily in hydrophobic organic solvents, can be obtained.

When the amphiphilic polymer is a polyionic complex of a polyamic acid with a cationic lipid, an anisotropic conductive film having a porous film consisting of polyimide with superior heat resistance can be obtained by performing imidization after film-forming.

In the anisotropic conductive film according to the invention, when the diameter of the holes in the porous film is smaller than the narrowest gap between the plural conductors provided to the connection targets, and the gaps between the holes is smaller than the narrowest width of these conductors, the insulation in the film surface direction is reliable and a high connection reliability is obtained.

In the anisotropic conductor film according to the invention, when the conductive material consists of a group of conductive particles, the holes are easy to fill uniformly with the conductive particles, so superior conductivity in the film thickness direction is obtained. When the conductive particles are particles of metal, the melting point of the metal can be lowered by reducing the particle size, which makes it easy to fusion bond the particles by heating at a low temperature.

If the group of metal particles filling the holes are fusion bonded by heating to be integral, spaces between the metal particles become small so the contact resistance decreases, and the electrical resistance in the film thickness direction can be reduced. Also, since the organic material which is present between metal particles is removed by fusion bonding, the electrical resistance in the film thickness direction is further reduced thereby.

If the metal of the metal particles consists of one or more metals selected from among Ag, Au, Pt, Ni, Cu and Pd, electrical conductivity is excellent and conductivity in the film thickness direction can easily be obtained.

In the anisotropic conductive film according to the invention, when the adhesive layer is a prepreg of a thermosetting resin in a semi-cured state, the adhesive layer in interstices between the conductors provided to the connection targets easily flows out and adhesion to the connection targets is enhanced, so that high reliability can be ensured.

In this case, when the thermosetting resin is an epoxy resin, there is superior adhesion to the connection targets.

At the same time, in the method of manufacturing the anisotropic conductive film according to the invention, as compared to the conventional anisotropic conductive film wherein conductive particles are dispersed in a resin, an anisotropic conductive film which is capable of responding to further pitch reduction of connection targets while maintaining connection reliability, can be manufactured.

When the aforesaid porous film is formed by a method wherein a supporting substrate on which cast is a polymer solution containing at least a hydrophobic, volatile organic solvent, a polymer soluble in this organic solvent and an amphiphilic material, or a polymer solution containing at least a hydrophobic, volatile organic solvent and an amphiphilic polymer, is left in the atmosphere at a relative humidity of 50% or more, a porous film having numerous holes in a honeycomb arrangement can be easily formed. Therefore, an anisotropic conductive film can be manufactured economically.

According to the other method of manufacturing the anisotropic conductor film according to the invention, as compared to the conventional anisotropic conductive film wherein conductive particles are dispersed in a resin, an anisotropic conductor film which is capable of responding to further pitch reduction of connection targets while maintaining connection reliability, can be manufactured.

When the porous film wherein holes are filled by a conductive material, is formed by leaving a supporting substrate on which cast is a polymer solution containing at least a hydrophobic, volatile organic solvent, a polymer soluble in this organic solvent, an amphiphilic material and a conductive material, or a polymer solution containing at least a hydrophobic, volatile organic solvent, an amphiphilic polymer and a conductive material, in the atmosphere at a relative humidity of 50% or more, there is no need to refill the holes in the porous film with the conductive material, so the anisotropic conductive film can be manufactured more economically.

### BRIEF DESCRIPTION OF DRAWINGS

FIG. 1 is a cross-sectional view schematically showing the structure of an anisotropic conductive film according to the invention.

FIGS. 2A and 2B are views schematically showing the structure of a porous film in the anisotropic conductive film according to the invention. FIG. 2A is a cross-sectional view of the porous film, and FIG. 2B is a plan view of the porous film.

FIG. 3 is a view schematically showing a state where holes in the porous film shown in FIGS. 2A and 2B are filled with a conductive material.

FIG. 4 is a view schematically showing a principle whereby a porous film having numerous holes in a honeycomb arrangement is spontaneously formed.

FIGS. 5A and 5B are views schematically showing the method of using the anisotropic conductive film according to the invention.

FIG. 6 shows an electron microscope image of a porous film consisting of polysulfone obtained when an anisotropic conductive film of Example 1 is manufactured.

FIG. 7 shows an electron microscope image of a porous film, wherein holes are filled by Ag particles, obtained when the anisotropic conductive film of Example 1 is manufactured.

FIG. 8 shows an electron microscope image of a porous film consisting of polysulfone obtained when an anisotropic conductive film of Example 2 is manufactured.

FIG. 9 shows an electron microscope image of a porous film, wherein holes are filled by Ag particles, obtained when the anisotropic conductive film of Example 2 is manufactured.

FIG. 10 shows an electron microscope image of a porous film consisting of siloxane-modified polyimide, obtained when an anisotropic conductive film of Example 3 is manufactured.

FIG. 11 shows an electron microscope image of a porous film, wherein holes are filled by Ag particles, obtained when the anisotropic conductive film of Example 3 is manufactured.

FIG. 12 shows an electron microscope image of a porous film consisting of siloxane-modified polyimide obtained when an anisotropic conductive film of Example 4 is manufactured.

FIG. 13 shows an electron microscope image of a porous film, wherein holes are filled by Ag particles, obtained when the anisotropic conductive film of Example 4 is manufactured.

FIG. 14 is a view schematically showing a comb-shaped electrode, which is used when an evaluation of anisotropic conductivity is performed.

FIG. 15A is a view schematically describing the evaluation of conduction performance in the film thickness direction, and FIG. 15B is a view schematically describing the evaluation of insulation performance in the film surface direction.

FIGS. 16A and 16B are views showing the structure and connection principle of a conventional anisotropic conductive film.

### BEST MODE FOR CARRYING OUT THE INVENTION

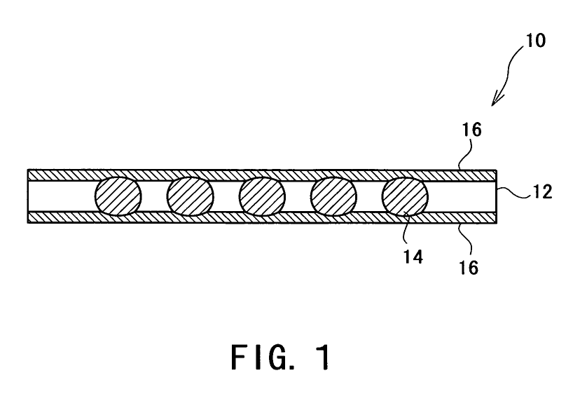

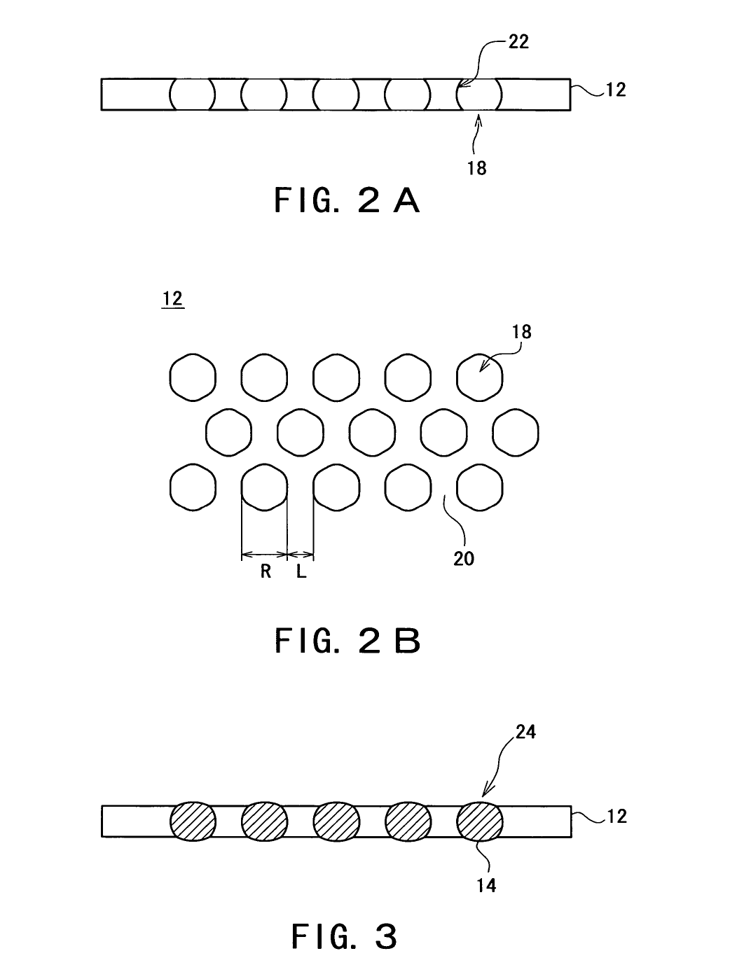

One preferred embodiment of the present invention will now be described in more detail referring to the drawings. FIG. 1 is a cross-sectional view schematically showing the structure of an anisotropic conductive film according to the invention. FIGS. 2A and 2B are views schematically showing the structure of a porous film in the anisotropic conductive film according to the invention. FIG. 3 is a view schematically showing a state where holes in the porous film shown in FIGS. 2A and 2B are filled with a conductive material.

First, the structure of the anisotropic conductive film (hereafter, “ACF”) according to the invention will be described referring to FIGS. 1 to 3.

As shown in FIG. 1, this ACF 10 basically includes a porous film 12, a conductive material 14, and adhesive layers 16.

In this ACF 10, the porous film 12 is formed from a polymer, and as shown in FIG. 2A, it has numerous holes 18 penetrating in the film thickness direction. Inner wall surfaces 22 of these holes 18 curve outwards in an approximately spherical shape. As shown in FIG. 2B, these holes 18 are in a honeycomb arrangement, adjacent holes 18 being separated by a wall 20.

Here, the diameter of the holes and the gaps between them in the porous film may be determined taking account of the widths of plural conductors (e.g., projecting electrodes, circuit patterns) in connection targets (e.g., IC chips and flexible printed circuits: FPC), and the gaps between them.

Also, from the viewpoint of ensuring insulation in the film surface direction and obtaining high connection reliability, it is preferred that the diameter of the holes is smaller than the narrowest gap between the plural conductors provided to the connection targets, and that the gaps between the holes are smaller than the narrowest width of the plural conductors provided to the connection targets.

Preferably, the diameter of the holes is ½ or less than the narrowest gap between the plural conductors provided to the connection targets, and the gaps between the holes are ½ or less than the narrowest width of the plural conductors provided to the connection targets.

As shown in FIG. 2B, the diameter of a hole means the average value obtained by measuring the diameter R of the hole opening of a hole on the film surface or under-surface, and the gap between the holes means the average value obtained by measuring the distance L between the hole opening of a hole and the hole opening of its adjacent hole on the film surface or under-surface. The diameter R and distance L may be measured by taking an electron micrograph or optical micrograph of the porous film surface.

The thickness of the porous film may be determined taking account of the mechanical strength, withstand voltage characteristics, etc., of the ACF. It is preferably within the range of 1-100 μm, and more preferably within the range of 5-50 μm.

Specific examples of the polymer forming the porous film are polysulfone, polyethersulfone, polyphenylene sulfide, polyimide, polyamide-imide, siloxane-modified polyimide, siloxane-modified polyamide-imide, polyether imide, polyether ether ketone, polyester, polyamide, and fluorocarbon resins such as polytetrafluoroethylene. These may be used alone, or a mixture of two or more may be used.

Among these, polysulfone, polyethersulfone, polyphenylene sulfide, polyimide, polyamide-imide, siloxane-modified polyimide, siloxane-modified polyamide-imide, polyether imide and polyether ether ketone are preferred due to their superior heat resistance.

In this ACF, the conductive material 14 basically fills the holes 18 in the porous film 12 as shown in FIG. 3. From the viewpoint of increasing the reliability of electrical connection in the film thickness direction, it is preferred that the conductive material 14 has projections 24 which project slightly outside the holes 18.

In this case, the height of the projections may be determined taking account of the variations in height of the conductors provided to the connection targets. This is preferably within the range of 0.1-10 μm, and more preferably 1-5 μm.

To make it easier to fill the small holes uniformly, and from the viewpoint of superior conductivity in the film thickness direction, the conductive material preferably consists of a group of conductive particles. The average size of the conductive particles may be determined according to the hole diameter of the porous film. Preferably, it is about 1 μm or less.

Specific examples of the conductive particles are metal particles, resin plated particles and carbon particles. These may be used alone, or a mixture of two or more may be used.

Among these conductive particles, metal particles are preferred. This is because their electrical resistance is small and the reduction in particle size leads to a decrease in the melting point of the metal, so they can be easily fusion bonded by heating at a low temperature.

Examples of the metal particles are Ag particles, Au particles, Pt particles, Ni particles, Cu particles and Pd particles. These may be used alone, or a mixture of two or more may be used. These metal particles have excellent electrical conductivity, so it is easy to obtain conductivity in the film thickness direction. Among these metal particles, Ag particles are preferably used.

Here, when the conductive particles are metal particles or resin plated particles which are particles at least a surface of which includes metal, the group of particles filling the holes are preferably fusion bonded by heating to be integral. This is because spaces between the particles are thereby reduced and the contact resistance decreases, so that the electrical resistance in the film thickness direction is reduced. Also, the fusion bonding removes an organic material which is present between the particles, so that the electrical resistance in the film thickness direction is reduced.

In the ACF, the conductive material may fill all the holes in the porous film, or there may be certain locations where the conductive material does not fill the holes. In other words, it is essential only that at least one of the holes facing the conductors provided to the connection targets is filled with the conductive material.

In this ACF, as shown in FIG. 1, the adhesive layer 16 is coated on the surface and under-surface of the porous film 12 wherein the holes 18 are filled with the conductive material 14.

The thickness of this adhesive layer may be determined taking account of the height of the conductors and the gaps between them provided to the connection targets. Preferably, it may be within the range of 0.1-100 μm, but more preferably 1-50 μm.

Here, the adhesive layer material may be any material which adheres to and insulates the connection targets. A preferred example is that of a prepreg in which a thermosetting resin, such as an epoxy resin, unsaturated polyester resin, bis-maleimide resin or cyanate resin, is semi-cured. When the adhesive layer is a prepreg, the adhesive layer easily flows into interstices between the conductors provided to the connection targets and contact adhesion with the connection targets is enhanced, so that high contact reliability can be maintained.

From the viewpoint of superior adhesion with the connection targets, the above thermosetting resin is preferably an epoxy resin.

Next, the method of manufacturing the ACF having the aforesaid structure will be described. The method of manufacturing the ACF basically includes a step for forming a porous film, a step for filling holes in the porous film with a conductive material, and a step for coating both surfaces of the porous film with an adhesive layer, or alternatively, a step for forming a porous film wherein holes are filled with a conductive material, and a step for coating both surfaces of the porous film with an adhesive layer.

(Formation of Porous Film)

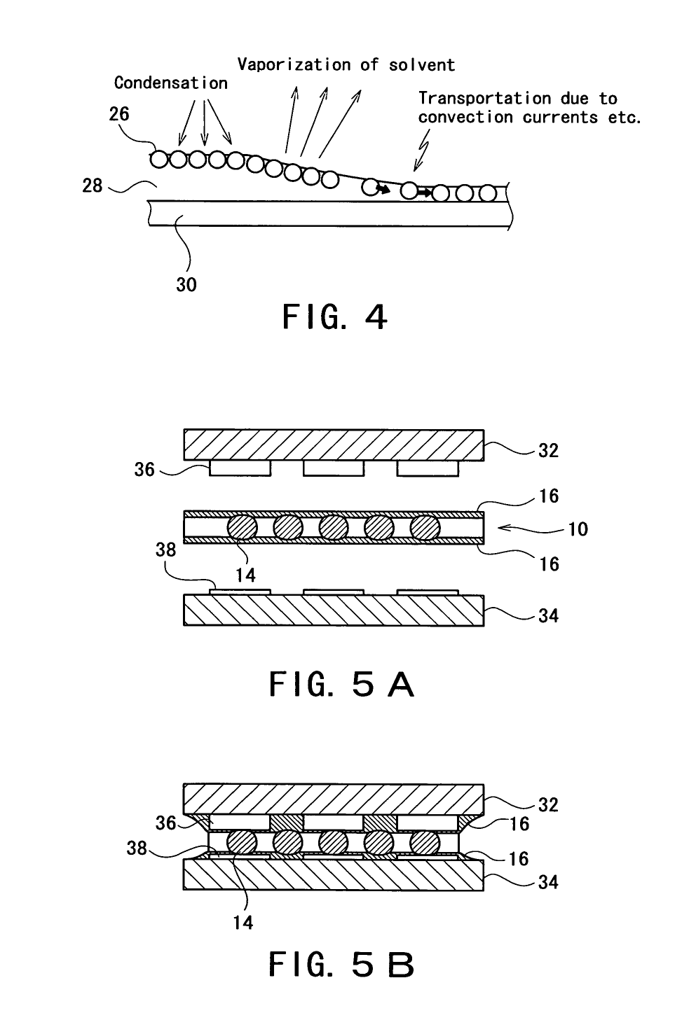

In the method of manufacturing the ACF, the porous film can be basically formed by the following technique. First, the outline and principles of the technique will be described referring to FIG. 4. This technique, simply described, is such that a polymer is dissolved in a volatile organic solvent without admixture of water, and a supporting substrate on which this polymer solution is cast is then left under high humidity conditions.

In this technique, a porous film having numerous holes in a honeycomb arrangement is spontaneously formed by the following principle. As shown in FIG. 4, 1) Water molecules in the air condense to water droplets 26 due to the latent heat when the organic solvent vaporizes, and become closely packed on the surface of a polymer solution 28. 2) Due to convection currents and capillary forces produced in the polymer solution 28 by the latent heat, the water droplets 26 are transported to the interface between the polymer solution 28 and a supporting substrate 30. 3) The water droplets 26 are fixed on the surface of the supporting substrate 30 due to the receding of the organic solvent. 4) The porous film 12 having the numerous holes 18 in a honeycomb arrangement is then formed by the vaporization of the water droplets 26, the regularly-arranged water droplets 26 acting as a mold. Since the water droplets 26 act as a mold, the inner wall surfaces 22 of the holes 18 assume a shape which curves outwards.

Hereafter, the method of manufacturing the ACF will be described in more detail. The polymer solution includes at least a hydrophobic, volatile organic solvent, a polymer which is soluble in this organic solvent, and an amphiphilic material.

Examples of the hydrophobic, volatile organic solvent are halogen compounds such as chloroform and methylene chloride, aromatic hydrocarbons such as benzene, toluene and xylene, esters such as ethyl acetate and butyl acetate, and ketones such as methylethyl ketone (MEK) and acetone. These may be used alone, or a mixture of two or more may be used.

Examples of the polymer soluble in the organic solvent are polysulfone, polyether sulfone, polyphenylene sulfide, siloxane-modified polyimide, and siloxane-modified polyamide-imide. These may be used alone, or a mixture of two or more may be used. If polyimide and polyamide-imide are used, modification by siloxane is made to enhance solubility in the organic solvent.

Here, the amphiphilic material means a so-called surfactant, which is a compound having surfactant activity, and has both hydrophobic sites and hydrophilic sites. This amphiphilic material is added mainly in order to stabilize the water droplets produced on the surface of the polymer solution. It can be postulated that the stabilization of the water droplets takes place due to the fact that the hydrophobic part of the amphiphilic material is highly compatible with the hydrophobic organic solvent, so water is easily retained in the spaces of the reverse micelles formed thereby.

Examples of an amphiphilic material are a polymer having a hydrophilic acrylamide polymer as a main chain skeleton, a dodecyl group as a hydrophobic side chain, and a lactose or carboxyl group as a hydrophilic side chain, or alternatively, a polyionic complex of an anionic polysaccharide such as heparin or dextran sulphate with a quarternary, long chain alkyl ammonium salt. These may be used alone, or a mixture of two or more may be used.

The concentration of the polymer in the polymer solution is 0.1-50 weight %, or more preferably 0.1-10 weight %.

If the concentration of the polymer is within the above range, a porous film of sufficient mechanical strength and adequate honeycomb structure can be obtained.

The amphiphilic material in the polymer solution is added within a range of 0.01-20 weight % or preferably 0.05-10 weight % to the polymer.

If the amphiphilic material is within this range, the obtained honeycomb structure is stable.

In the method of manufacturing the ACF, in the step for forming the porous film, a polymer solution containing at least a hydrophobic, volatile organic solvent, and an amphiphilic polymer, may be used instead of the polymer solution described above.

Here, an amphiphilic polymer means a polymer having both hydrophobic sites and hydrophilic sites.

Examples of an amphiphilic polymer are a polyionic complex of a polymer such as polyether ether ketone, polyimide, polyamide-imide and polyether imide wherein a hydrophilic group such as —SO₃H or —COOH has been introduced into the main chain and/or side chain, with a cationic lipid, and a polyionic complex of a polyamic acid with a cationic lipid.

In the above, the polyamic acid is a resin compound obtained by polymerizing a tetracarboxylic dianhydride with a diamine compound in a polar solvent.

Examples of a polyamic acid are tetracarboxylic acids having a biphenyl structure such as 3,3′,4,4′-biphenyl tetracarboxylic acid, 3,3′,4,4′-biphenylether tetracarboxylic acid, 3,3′,4,4′-biphenyl sulfone tetracarboxylic acid, 3,3′,4,4′-benzophenone tetracarboxylic acid, 2,2-bis-(3,4-dicarboxyphenyl) propane, 1,1,1,3,3,3-hexafluoro-2,2-bis-(3,4-dicarboxyphenyl) propane, bis-(3,4-dicarboxyphenyl) tetra-methyldisiloxane, and their dianhydrides; alicyclic tetracarboxylic acids such as cyclobutane tetracarboxylic acid, 1,2,3,4-cyclopentane tetracarboxylic acid, 2,3,4,5-tetrahydrofuran tetracarboxylic acid, 1,2,4,5-cyclohexane tetracarboxylic acid, 3,4-dicarboxy 1-cyclohexylsuccinic acid, 3,4-dicarboxy-1,2,3,4-tetrahydro-1-naphthalene succinic acid, and their dianhydrides; and aromatic tetracarboxylic acids such as pyromellitic acid, 2,3,6,7-naphthalene tetracarboxylic acid, 1,2,5,6-naphthalene tetracarboxylic acid, 1,4,5,8-naphthalene tetracarboxylic acid, 2,3,6,7-anthracene tetracarboxylic acid, 1,2,5,6-anthracene tetracarboxylic acid, 2,3,4,5-pyridine tetracarboxylic acid, 2,6-bis-(3,4-dicarboxyphenyl)pyridine, and their dianhydrides; pyromellitic acid and trimellitic acid. These may be used alone, or a mixture of two or more may be used.

Examples of a diamine compound are aromatic diamines such as p-phenylenediamine, m-phenylenediamine, 2,5-diaminotoluene, 2,6-diaminotoluene, 4,4-diaminobiphenyl, 3,3′-dimethyl-4,4′-diaminobiphenyl, 3,3′-dimethoxy-4,4′-diaminobiphenyl, diaminodiphenylmethane, diaminodiphenyl ether, 2,2′-diaminodiphenyl propane, bis-(3,5-diethyl-4-aminophenyl) methane, diaminodiphenyl sulfone, diaminobenzophenone, diaminonaphthalene, 1,4-bis-(4-aminophenoxy) benzene, 1,4-bis-(4-aminophenyl) benzene, 9,10-bis-(4-aminophenyl) anthracene, 1,3-bis-(4-aminophenoxy) benzene, 4,4′-bis-(4-aminophenoxy) diphenylsulfone, 2,2-bis-[4-(4-aminophenoxy) phenyl]propane, 2,2′-trifluoromethyl-4,4′-diaminobiphenyl, and 4,4′-bis-(4-diaminophenoxy) octafluorobiphenyl; alicyclic diamines such as bis-(4-aminocyclohexyl) methane and bis-(4-amino-3-methylcyclohexyl) methane; and aliphatic amines such as tetramethylenediamine and hexamethylenediamine; and diaminosiloxane. These may be used alone, or a mixture of two or more may be used.

Examples of a cationic lipid are aliphatic ammonium salts having four or more carbon atoms, and alicyclic ammonium salts.

Specific examples are salts of primary amines such as octylamine, decylamine, tetradecylamine, hexadecylamine, stearylamine, docosylamine and cyclohexylamine; salts of secondary amines such as dipentylamine, dihexylamine, dioctyl amine, didecylamine, ditetradecyl amine, dihexadecyl amine, distearylamine, didocosylamine, N-methyl octylamine, N-methyl n-decyl amine, N-methyl n-tetradecylamine, N-methyl n-hexadecyl amine, N-methyl n-octadecyl amine, N-methyl n-ecosyl amine, N-methyl n-docosyl amine and N-methyl n-cyclohexylamine; salts of tertiary amines such as N,N-dimethyl octylamine, N,N-dimethyl n-decyl amine, N,N-dimethyl n-tetradecylamine, N,N-dimethyl n-hexadecyl amine, N,N-dimethyl n-octadecyl-amine, N,N-dimethyl n-ecosyl-amine, N,N-dimethyl n-dodecyl-amine and N,N-dimethyl n-cyclohexylamine; and salts of quartenary amines such as dimethyl dioctylamine, dimethyl didecylamine, dimethyl ditetradecyl amine, dimethyl dihexadecyl amine, dimethyl dioctadecyl amine, dimethyldieicosyl amine, dimethyldidodecyl amine and dimethyl dicyclohexylamine. These may be used alone, or a mixture of two or more may be used.

The aforesaid polyionic complex of a polyamic acid with a cationic lipid may be obtained by blending the cationic lipid, or a solution of the cationic lipid in an organic solvent which can be used for polymerizing the aforesaid amic acid, with a solution containing the product of neutralizing the polyamic acid with a base.

When a polyionic complex of a polyamic acid with a cationic lipid is used, the film which is formed is preferably imidized by a method known in the art. This is in order to close the ring of the polyamic acid to form a porous film of polyimide.

In the porous film-forming step, when a polymer solution containing at least a hydrophobic, volatile organic solvent, and an amphiphilic polymer, is used, the concentration of the amphiphilic polymer in the polymer solution is 0.1-50 weight %, and preferably 0.1-10 weight %.

If the concentration of the amphiphilic polymer is within this range, a porous film having sufficient mechanical strength and an adequate honeycomb structure can be obtained.

The hydrophobic, volatile organic solvent is identical to that described above, so its description will not be repeated here.

When the aforesaid porous film is formed, the material of the supporting substrate on which the polymer solution is cast may be an inorganic material such as glass, metal or silicon wafer, a polymer material such as polypropylene, polyethylene, polyether ketone or a fluorinated resin, water, or liquid paraffin.

The casting amount of the polymer solution may be suitably adjusted so that the diameter of the holes in the porous film is smaller than the narrowest gap between the plural conductors provided to the connection targets, and so that the gaps between the holes are less than the narrowest width of the plural conductors provided to the connection targets.

Specifically, the casting amount of the polymer solution is preferably such that the coating thickness is 50-3500 μm, and preferably 150-2000 μm.

The supporting substrate on which the polymer solution is cast is preferably left in the atmosphere at a relative humidity of 50%-95%. If the relative humidity is less than 50%, condensation tends to be inadequate, and if it exceeds 95%, it is difficult to control the environment.

In the aforesaid porous film-forming step, the polymer solution may be cast on a supporting substrate in the atmosphere at a relative humidity of 50%-95%, or a supporting substrate on which the polymer solution has been cast previously, may be left in the atmosphere at a relative humidity of 50%-95%. Alternatively, air having a relative humidity of 50%-95% may be blown over the polymer solution.

In the aforesaid porous film-forming step, in order to promote vaporization of the organic solvent, or vaporization of the water droplets on the surface of the polymer solution, heating and drying may be performed to the extent that it does not interfere with formation of the porous film.

(Filling of Conductive Material)

Next, in the method of manufacturing the ACF, the technique of filling the holes in the porous film with a conductive material is suitably selected taking account of the type and form of the conductive material used.

The conductive material may be filled by for example further containing the conductive material in the aforesaid polymer solution. Hence, when the conductive material is also contained in the polymer solution used when the porous film is manufactured, a porous film wherein the holes are already filled with the conductive material in the film-forming step, is formed spontaneously. According to this method, it is not necessary to refill the holes in the porous film with the conductive material, so the step for filling the holes in the porous film with the conductive material can be omitted.

The conductive material content in the polymer solution is 1-52 weight %, and preferably 1-10 weight %. Also, the conductive material preferably consists of conductive particles having an average particle size of about 1 μm or less.

Another method of filling the conductive material is for example to disperse the conductive material in a solvent in which the polymer is insoluble, and immerse the porous film in this dispersion solvent, so that the conductive material is adsorbed in the holes and slightly outside the holes. In this case, the solvent may be for example an alcoholic solvent such as ethanol, water, an ester solvent, amide solvent, hydrocarbon solvent, ketone solvent or ether solvent.

The conductive material content in the dispersion solvent is 1-80 weight %, and preferably 1-10 weight %. The conductive material preferably consists of conductive particles having an average particle size of about 1 μm or less. The speed with which the porous film is lifted out of the dispersion solvent and the immersion time may be adjusted depending on the hole diameter of the porous film and the conductive material content in the dispersion solvent.

Alternatively, for example, if metal particles are to be used as the conductive particles, the porous film may be laid on a glass substrate or the like which has been surface-modified by an alkoxide of an identical metal with the metal particles, and this may be immersed in the dispersion solvent so that the conductive material is selectively adsorbed in the holes and slightly outside the holes.

In this case, the metal alkoxide used may be an alkoxide of Cu, Ni, Ti, Fe or the like.

Still further, for example, if metal particles are to be used as the conductive particles, a metal film may be stuck to one surface of the porous film, electroplating then performed using this as an electrode, and the metal film removed by etching so that metal particles are selectively deposited in the holes and slightly outside the holes.

(Formation of Adhesive Layer)

Next, in the method of manufacturing the ACF, an adhesive layer may be coated on both surfaces of the porous film, wherein the holes are filled with the conductive material, by coating an adhesive layer material by coating means known in the art such as a coater, or laminating a film of the adhesive layer which has been previously prepared.

Next, the method of using the ACF will be described referring to FIGS. 5A and 5B. As shown in FIGS. 5A and 5B, the ACF 10 is for example interposed between a substrate 32 and a substrate 34 and hot press is performed for a short time at a temperature at which the adhesive layers 16 flow so that the adhesive layers 16 flow out, and the conductive material 14 is sandwiched between an electrode 36 of the substrate 32 and an electrode 38 of the substrate 34. When the resin cures while this state is maintained, the electrodes 36, 38 become electrically connected to each other via the conductive material 14. On the other hand, the adjacent electrodes 36 (38) are electrically insulated by the adhesive layers 16. Also, due to the curing of the adhesive layers 16, the substrate 32 and the substrate 34 become mechanically connected to each other.

The invention is not be construed as being limited by the aforesaid embodiments, and various modifications are possible within the scope of the present invention.

### EXAMPLES

The invention will now be described in more detail referring to Examples.

1. Manufacture of Anisotropic Conductive Film According to Examples

### Example 1

A polymer solution was prepared by adding 10 weight % of a copolymer of dodecyl acrylamide and caproic acid relative to polysulfone as an amphiphilic material to a solution containing 0.1 weight % of polysulfone (Aldrich, molecular weight Mw=56,000) in chloroform.

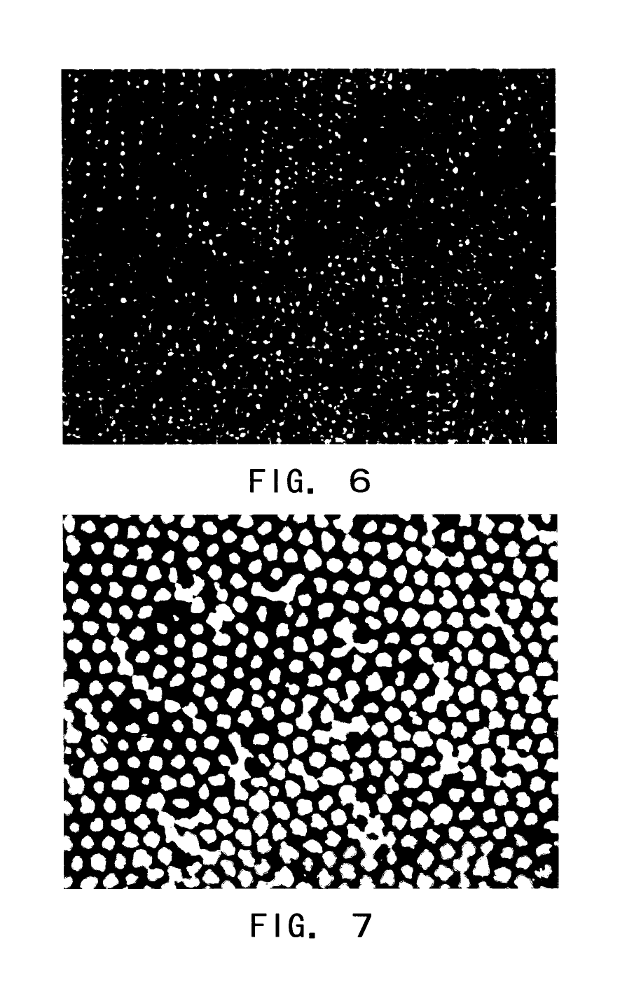

Next, this polymer solution was cast at a coating film thickness of 780 μm onto a Petri dish (diameter: 90 mm) over which air at a relative humidity of 50% was blown continuously to vaporize the chloroform. As a result, as shown in FIG. 6, a porous film consisting of polysulfone, having numerous holes penetrating in the film thickness direction in a honeycomb arrangement, wherein the inner wall surfaces of the holes curved outwards, was obtained. The diameter of the holes in the porous film was about 5 μm.

Next, this porous film was immersed in an Ag ethanol dispersion solvent at a concentration of 3 weight % (NIPPON PAINT Co., Ltd., “Fine Sphere SVE 102”, average particle size 50 nm), and lifted up at a speed of 5 μm/sec. As a result, as shown in FIG. 7, a porous film wherein the holes were filled by Ag particles was obtained. The filling Ag particles were fusion bonded by heating at 150° C. for 5 minutes.

Next, an adhesive layer was prepared by dissolving bisphenol A epoxy resin (Japan Epoxy Resins Co., Ltd., “Epicoat 1001”, NBR (ZEON Corporation, “Nipol 1072J”) and Imidazole curing agent (SHIKOKU CHEMICALS CORPORATION, “Curezol C11Z”), in a polymerization ratio of bisphenol A epoxy resin:NBR:imidazole curing agent=40:50:5, in a mixed solvent of MEK/THF=50/50 so that solids accounted for 30 weight %, and this solution was dried at 60° C. for 10 minutes.

Next, this adhesive layer was laminated on both surfaces of the porous film wherein the holes were filled with Ag particles so as to manufacture an anisotropic conductive film according to Example 1.

### Example 2

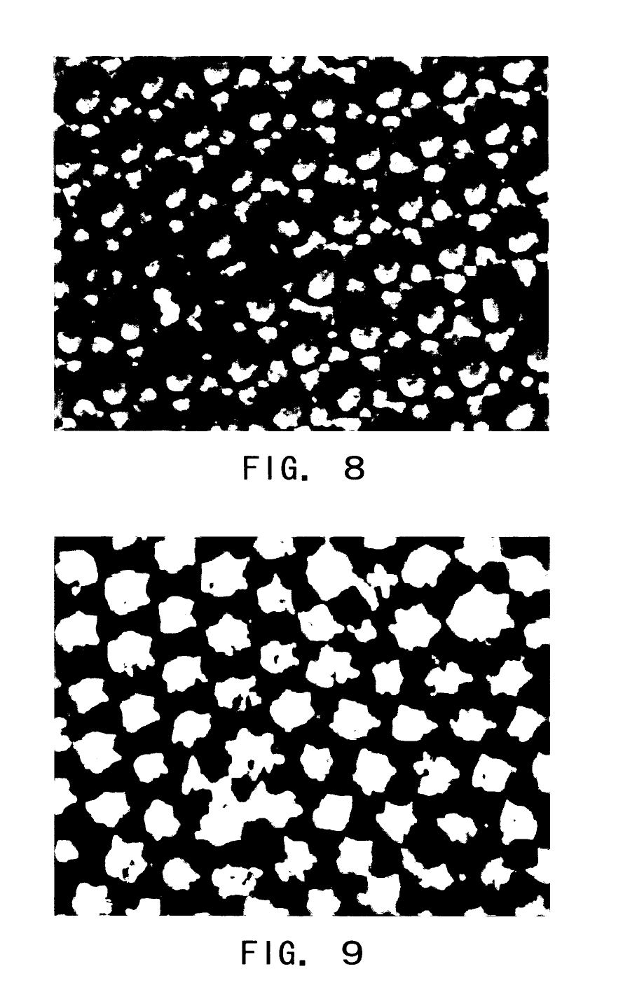

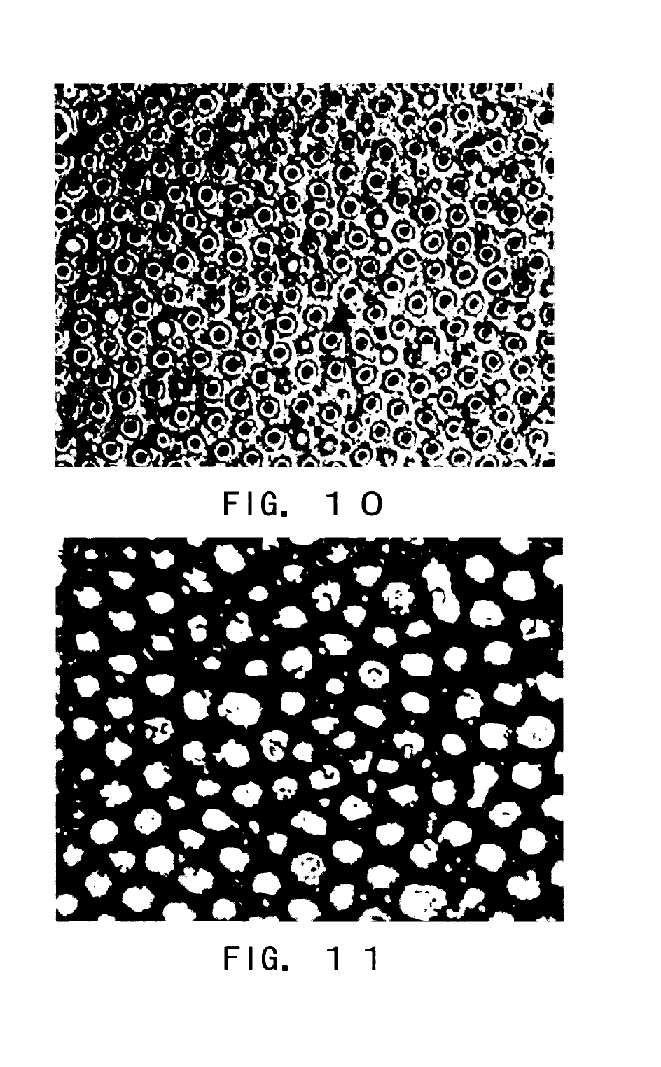

An anisotropic conductive film according to Example 2 was manufactured in an identical way to that of Example 1, except that polysulfone was dissolved in chloroform at a concentration of 0.2 weight %, and the coating film thickness was 1560 μm. FIG. 8 and FIG. 9 respectively show a porous film consisting of polysulfone and a porous film wherein the holes were filled with Ag particles, obtained when the anisotropic conductive film according to Example 2 was manufactured. The hole diameter of the porous film was about 10 μm.

### Example 3

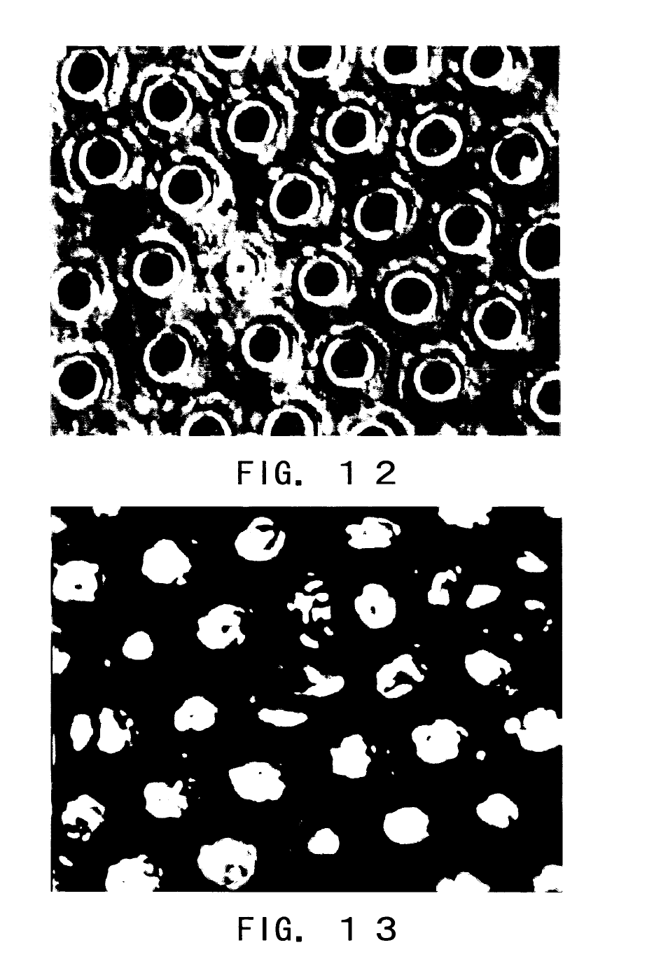

An anisotropic conductive film according to Example 3 was manufactured in an identical way to that of Example 1, except that instead of polysulfone, siloxane-modified polyimide (UBE INDUSTRIES LTD., “R15”) was dissolved in chloroform at a concentration of 0.1 weight %, and the porous film was lifted up at a speed of 7 μm/sec after immersion in the Ag ethanol dispersion solvent. FIG. 10 and FIG. 11 respectively show a porous film consisting of siloxane-modified polyimide and a porous film wherein the holes were filled with Ag particles, obtained when the anisotropic conductive film according to Example 3 was manufactured. The hole diameter of the porous film was about 5 μm.

### Example 4

An anisotropic conductive film according to Example 4 was manufactured in an identical way to that of Example 3, except that the siloxane-modified polyimide was dissolved in chloroform at a concentration of 0.2 weight %, the coating film thickness was 1560 μm, and the porous film was lifted up at a speed of 5 μm/sec after immersion in the Ag ethanol dispersion solvent. FIG. 12 and FIG. 13 respectively show a porous film of siloxane-modified polyimide and a porous film wherein the holes were filled with Ag particles, obtained when the anisotropic conductive film according to Example 4 was manufactured. The hole diameter of the porous film was about 13 μm.

### Example 5

A polyamic acid solution was prepared by reacting the polyamic acid of 29.4 g (0.1 mole) of biphenyl tetra carboxylic acid anhydride (BPDA) and 20.0 g (0.1 mole) of diamino diphenyl ether (DDE) in 278 g of N-methyl-2-pyrrolidone (NMP) at 23° C. for 24 hours. Next, this solution was gradually introduced into 2 L of ethyl acetate, re-precipitated, filtered and dried to obtain 35.0 g of polyamic acid powder.

Next, 100 mg of this polyamic acid was dissolved in water at pH 8 with heating. Separately, 200 mg of dimethyl dioctadecyl ammonium bromide was dispersed in 200 mL of water while applying ultrasound. Next, the aforesaid two solutions were mixed, the temperature was returned to room temperature and the mixture left overnight with stirring. Subsequently, chloroform was added, and the chloroform phase was extracted in a separating funnel. Next, the chloroform was concentrated on the evaporator, and re-precipitated with acetone. Next, it was centrifuged in a centrifuge at 2600 rpm for 30 minutes, and the solvent was dried (52.5 mg). Next, this polyionic complex solution was diluted so as to prepare a polymer solution at a concentration of 0.5 weight %.

Next, this polymer solution was cast to a film coating thickness of 780 μm on a Petri dish (diameter: 90 mm) over which air at a relative humidity of 50% was blown continuously to vaporize the chloroform. As a result, a precursor film consisting of a polyimide precursor wherein numerous holes penetrating in the film thickness direction were in a honeycomb arrangement, was obtained.

Next, this precursor film was immersed overnight in a solution of benzene:anhydrous acetic acid:pyridine=3:1:1, and the polyionic complex was imidized. In this way, a porous film consisting of polyimide, having numerous holes penetrating in the film thickness direction in a honeycomb arrangement, wherein the inner wall surfaces of these holes curved outwards, was obtained. At this time, the cationic lipid was removed by rinsing with ethanol. The hole diameter of the porous film was about 4 μm.

Next, the porous film was immersed in an Ag ethanol dispersion solvent (NIPPON PAINT Co., “Fine Sphere SVE 102”, average particle size: 50 nm) at a concentration of 3 weight %, and lifted up at a speed of 5 μm/sec. As a result, a porous film wherein the holes were filled with Ag particles was obtained. The Ag particles filling the holes were fusion bonded by heating at 150° C. for 5 minutes.

Next, an adhesive layer was manufactured by dissolving bisphenol A epoxy resin (Japan Epoxy Resins Co., Ltd.), NBR and an imidazole curing agent, as mentioned above, in a polymerization ratio of bisphenol A epoxy resin:NBR:imidazole curing agent=40:50:5, in a mixed solvent of MEK/THF=50/50 so that solids accounted for 30 weight %, and this solution was dried at 60° C. for 10 minutes.

Next, this adhesive layer was laminated on both surfaces of the porous film wherein the holes were filled with Ag particles so as to manufacture an anisotropic conductive film according to Example 5.

### Example 6

An anisotropic conductive film according to Example 6 was manufactured in an identical way to that of Example 5, except that a polymer solution having a concentration of 0.7 weight % was prepared by diluting the obtained polyionic complex solution, and that the coating film thickness was 1560 μm. The hole diameter of the porous film consisting of polyimide, obtained when the anisotropic conductive film according to Example 6 was manufactured, was about 8 μm.

2. Evaluation of Anisotropic Conductivity

Next, for each of the anisotropic conductive films in Examples as manufactured above, the anisotropic conductivity was evaluated by measuring conduction performance in the film thickness direction and insulation performance in the film surface direction.

(1) Conduction Performance in Film Thickness Direction

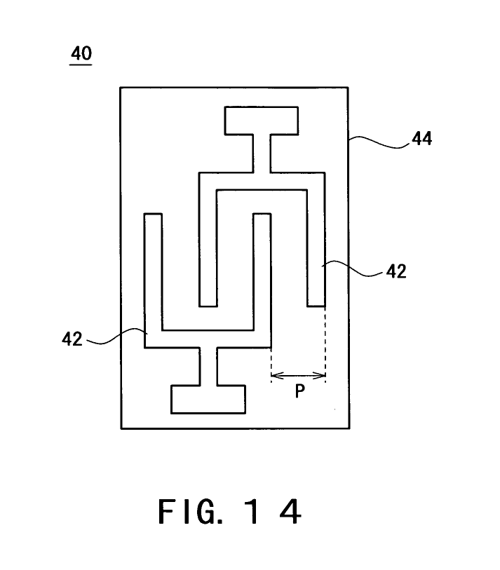

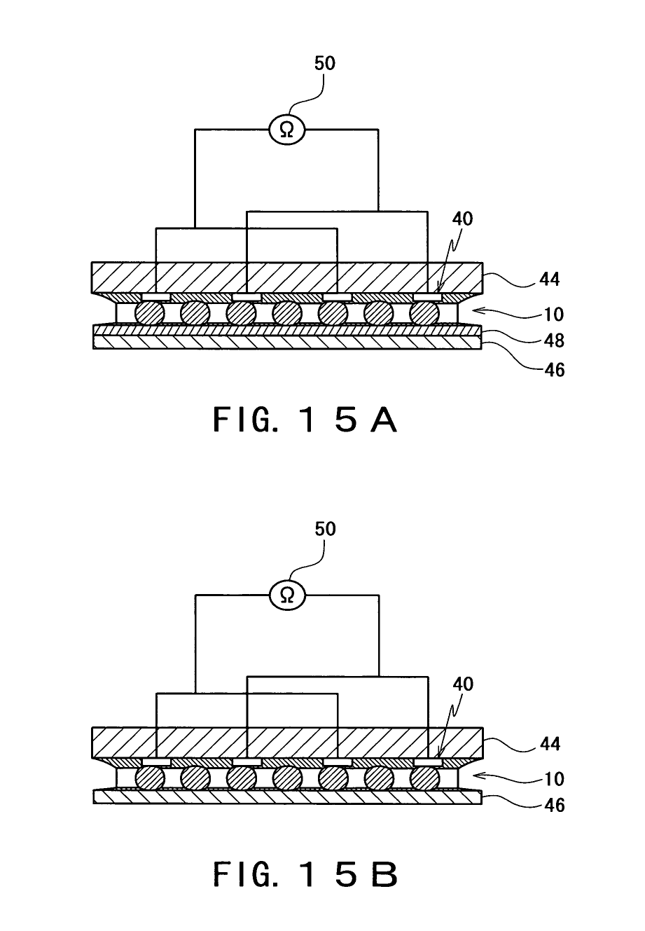

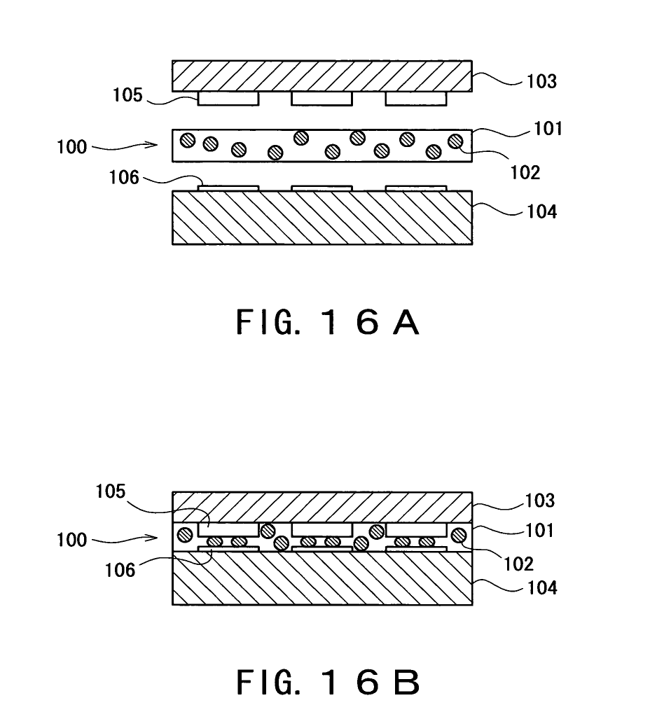

The conduction performance in the film thickness direction was evaluated as follows. One surface of each of the anisotropic conductive films according to Examples 1 to 6 was temporarily compression bonded to comb-shaped electrodes 40 (comb-shaped electrodes positioned so that adjacent electrodes 42, 42 were mutually insulated by an insulating substrate 44) having a predetermined pitch P as shown in FIG. 14. Next, as shown in FIG. 15A, an anisotropic conductive film 10 to which the comb-shaped electrodes 40 had been temporarily compression bonded, was mounted so that its other surface was in contact with a copper plate 48 laminated on a glass plate 46, and compression bonded at 170° C. for 20 sec.

Next, for samples A1 to A6 (the letter A is added to the number of each Example) obtained in this way, the conduction performance was evaluated by a tester 50. In this evaluation, for the anisotropic conductive films according to Example 1, Example 3 and Example 5, the pitch P of the comb-shaped electrode 40 was 30 μm, and for the anisotropic conductive films according to Example 4 and Example 6, the pitch P of the comb-shaped electrode 40 was 100 μm.

As a result of this evaluation, it was verified that for all the samples A1 to A6, the resistance value between the comb-shaped electrodes was 0Ω.

(2) Insulation Performance in Film Surface Direction

The insulation performance in the film surface direction was evaluated as follows. One surface of each of the anisotropic conductive films according to Examples 1 to 6 was temporarily compression bonded to the comb-shaped electrodes 40 identical to the aforesaid comb-shaped electrode. Next, as shown in FIG. 15B, the anisotropic conductive film 10 to which the comb-shaped electrodes 40 had been temporarily compression bonded, was mounted so that its other surface was in contact with the glass plate 46, and compression bonded at 170° C. for 20 sec.

Next, for samples B1 to B6 (the letter B is added to the number of each Example) obtained in this way, the insulation performance was evaluated by the tester 50. In this evaluation, the pitch P of the comb-shaped electrodes was identical to the above.

As a result of this evaluation, it was verified that for all the samples B1 to B6, the resistance value between the comb-shaped electrodes was 10⁸Ω or more.

These evaluation results show that the anisotropic conductive films according to Examples have sufficient anisotropic conductivity.

1. An anisotropic conductive film comprising:
a porous film consisting of polymer, having numerous holes penetrating in a film thickness direction, the holes being in a honeycomb arrangement and having inner wall surfaces which curve outwards;
a conductive material that fills the holes in the porous film; and
an adhesive layer coated on both surfaces of the porous film,
wherein the porous film is formed by leaving a supporting substrate on which cast is a polymer solution containing at least a hydrophobic, volatile organic solvent, a polymer soluble in this organic solvent and an amphiphilic material, or a polymer solution containing at least a hydrophobic, volatile organic solvent and an amphiphilic polymer, in the atmosphere at a relative humidity of 50% or more, or
the porous film and the conductive material are formed by leaving a supporting substrate on which cast is a polymer solution containing at least a hydrophobic, volatile organic solvent, a polymer soluble in this organic solvent, an amphiphilic material and a conductive material, or a polymer solution containing at least a hydrophobic, volatile organic solvent, an amphiphilic polymer and a conductive material, in the atmosphere at a relative humidity of 50% or more.

2. The anisotropic conductive film according to claim 1, wherein the polymer consists of one or more polymers selected from among polysulfone, polyethersulfone, polyphenylene sulfide, polyimide, polyamide-imide, siloxane-modified polyimide, siloxane-modified polyamide-imide, polyether imide and polyether ether ketone.

3. (canceled)

4. (canceled)

5. The anisotropic conductive film according to claim 1, wherein the polymer soluble in the organic solvent is one or more polymers selected from among polysulfone, polyethersulfone, polyphenylene sulfide, siloxane-modified polyimide and siloxane-modified polyamide-imide.

6. (canceled)

7. (canceled)

8. The anisotropic conductive film according to claim 1, wherein the amphiphilic polymer is a polyionic complex of a polymer having a hydrophobic group introduced into at least one of a main chain and a side chain, with a cationic lipid.

9. The anisotropic conductive film according to claim 1, wherein the amphiphilic polymer is a polyionic complex of a polyamic acid with a cationic lipid, and the porous film is imidized after film-forming.

10. The anisotropic conductive film according to claim 1, wherein a diameter of the holes is smaller than the narrowest gap between plural conductors provided to connection targets, and a gap between the holes is smaller than the narrowest width of the conductors.

11. The anisotropic conductive film according to claim 1, wherein the conductive material consists of a group of conductive particles.

12. The anisotropic conductive film according to claim 11, wherein the conductive particles are particles of metal.

13. The anisotropic conductive film according to claim 12, wherein the metal consists of one or more metals selected from among Ag, Au, Pt, Ni, Cu and Pd.

14. The anisotropic conductive film according to claim 12, wherein a group of the metal particles filling the holes are fusion bonded by heating to be integral.

15. The anisotropic conductive film according to claim 1, wherein the adhesive layer is a prepreg wherein a thermosetting resin is in a semi-cured state.

16. The anisotropic conductive film according to claim 15, wherein the thermosetting resin is an epoxy resin.

17. A method of manufacturing an anisotropic conductive film, comprising the steps of:
forming a porous film consisting of polymer, having numerous holes penetrating in a film thickness direction, the holes being in a honeycomb arrangement and having inner wall surfaces which curve outwards;
filling the holes in the porous film with a conductive material; and
coating both surfaces of the porous film with an adhesive layer,
wherein the porous film is formed by leaving a supporting substrate on which cast is a polymer solution containing at least a hydrophobic, volatile organic solvent, a polymer soluble in this organic solvent and an amphiphilic material, or a polymer solution containing at least a hydrophobic, volatile organic solvent and an amphiphilic polymer, in the atmosphere at a relative humidity of 50% or more.

18. (canceled)

19. (canceled)

20. A method of manufacturing an anisotropic conductive film, comprising the steps of:
forming a porous film consisting of polymer, having numerous holes penetrating in a film thickness direction, the holes being in a honeycomb arrangement, having inner wall surfaces which curve outwards and being filled with a conductive material; and
coating both surfaces of the porous film with an adhesive layer,
wherein the porous film is formed by leaving a supporting substrate on which cast is a polymer solution containing at least a hydrophobic, volatile organic solvent, a polymer soluble in this organic solvent, an amphiphilic material and a conductive material, or a polymer solution containing at least a hydrophobic, volatile organic solvent, an amphiphilic polymer and a conductive material, in the atmosphere at a relative humidity of 50% or more.

21. (canceled)

22. (canceled)
